(19) United States
(12) Patent Application Publication
(10) Pub. No.: US 2025/0390902 A1
(43) Pub. Date: Dec. 25, 2025

(54) PLATFORM FOR PRODUCT CATALOGING AND INVENTORY MANAGEMENT

(71) Applicant: 130 Point Enterprises Proprietary Limited, Point Cook (AU)

(72) Inventors: Kathryn Harrison, New York, NY (US); Selin Onar, New York, NY (US); Brian Spiegel, New York, NY (US)

(21) Appl. No.: 19/244,456

(22) Filed: Jun. 20, 2025

Related U.S. Application Data
(60) Provisional application No. 63/662,290, filed on Jun. 20, 2024.

(51) Int. Cl. G06Q 30/0201; G06Q 10/0875; G06Q 30/0601

(52) U.S. Cl. CPC G06Q 30/0206; G06Q 10/0875; G06Q 30/0633

(57) ABSTRACT

A platform simplifies the process of identifying and cataloging collectibles, specifically collectible cards (e.g., trading cards, sports cards, etc.). The platform can construct a catalog of various cards and use this catalog to identify and classify a card based on an image of the card. The platform includes capabilities to build-out/iterate the catalog when previously unknown cards are provided to the platform. A user's collection of cards can be managed and viewed within the platform. For dealers, the platform will allow the synchronization of inventory across multiple platforms, allowing dealers to list a larger portion of their collection for sale with minimal user involvement. Additionally, the platform includes a buy back button for “breakers” that allows for the participants in a case or pack break to immediately monetize the cards they receive in the break. Related apparatus, systems, techniques, and articles are also described.

### CROSS-REFERENCE TO RELATED APPLICATION

This application claims the benefit of U.S. Provisional Patent Application No. 63/662,290 filed Jun. 20, 2024, the contents of which are incorporated herein in their entireties.

### TECHNICAL FIELD

The subject matter described herein relates to product cataloging and inventory management.

### BACKGROUND

The collectibles space, particularly the collectible trading card market, encompasses a wide variety of trading cards. Each year, new trading cards and variations are released, giving users an opportunity to acquire and preserve new and unique cards. As trading card collections become more expansive, individuals will often manage and catalog their card collections.

Platforms for managing collectible cards often require manual user input for card identification and cataloging. Moreover, the continuous release of new cards and card variations requires users to track and manually add newly acquired cards. This process of identifying and tracking cards is often tedious and error prone, due to the wide variety of past and current versions of trading cards that are made. This process can be further complicated since many card and collectible creators may release different versions of the same or similar cards each year and there can be significant differences in the rarity of these card versions. Accordingly, it takes a great deal of skill and knowledge to be able to correctly identify collectibles and given the breadth and depth of the collectibles market it is extremely unlikely that an individual or group of individuals would have the necessary knowledge to identify and catalog a collectible from within the realm of collectibles and even those within a specific category of collectible, such as trading cards, figurines, etc.

### SUMMARY OF INVENTION

A platform simplifies the process of identifying and cataloging collectibles, such as collectible cards (e.g., trading cards, sports cards, etc.). While the foregoing described systems and methods are discussed in regards to trading card collectibles, the systems and methods (e.g., “platform”) can be used with other collectibles (e.g., figurines, toys, etc.) or combinations thereof. The platform includes a collectibles catalog of various cards, and this catalog can be used to identify and classify a card based on one or more features or characteristics of the card, such as those extracted from an image of the card or otherwise provided/input to the platform. The platform includes capabilities to build-out/iterate an overall platform catalog (e.g., master catalog), catalog of a collectible type, catalog of a manufacturer, catalog of a year and/or other catalogs of collectibles when previously unknown cards are provided to the platform. A user's collection of cards can be managed and viewed within the platform. For dealers, the platform allows the synchronization of inventory across multiple sales platforms, allowing dealers to list a larger portion of their collection for sale with minimal user involvement. Additionally, the platform includes a buy back button for “breakers” that allows for the participants in a break (e.g., case or pack break) to immediately monetize the cards they are allocated or receive in the break. Related apparatus, systems, techniques, and articles are also described.

In some aspects, the techniques described herein relate to a method including: receiving data corresponding to a physical collectible item, the data including at least one of an image, text, or audio; identifying the physical collectible item by applying a trained machine learning model on the received data to extract one or more features of the physical collectible item; retrieving a corresponding entry in a database for the identified physical collectible item and updating the corresponding entry to include the physical collectible item, when the corresponding entry is available; and generating a proposed entry in the database for the identified physical collectible item when the corresponding entry in the database is unavailable.

One or more of the following features can be included in any feasible combination. In some aspects, the techniques described herein relate to a method, wherein each entry in the database includes a confidence score. In some aspects, the techniques described herein relate to a method, wherein updating the corresponding entry to include the physical collectible item further includes increasing the confidence score. In some aspects, the techniques described herein relate to a method, further including: converting the proposed entry into a permanent entry in the database when the confidence score of the proposed entry exceeds a predetermined threshold. In some aspects, the techniques described herein relate to a method, further including updating the proposed entry based on received additional data. In some aspects, the techniques described herein relate to a method, wherein the data corresponding to the physical collectible item includes at least one of a photographic image, a textual description, keywords, metadata, a machine-readable barcode, a QR code, or a recorded voice annotation. In some aspects, the techniques described herein relate to a method, wherein the database is configured to synchronize on a periodic basis with at least one external structured data source, the external structured data source including at least one of a manufacturer-maintained product database, a third-party online marketplace catalog, and a user-generated public index, and wherein synchronization includes ingestion of one or more of item metadata, pricing information, and/or classification attributes. In some aspects, the techniques described herein relate to a method, further including: generating a listing for the physical collectible item based on the corresponding entry in a database for the identified physical collectible item. In some aspects, the techniques described herein relate to a method, wherein one or more parameters of the generated listing is updated based on a rule set and performance metrics associated with a corresponding sales channel, wherein the one or more parameters of the generated listing includes one or more of a formatting, pricing, and descriptive elements of the generated listing and wherein the rule set includes one or more of audience behavior patterns, platform-specific fee structures, and/or historical transaction velocity for comparable items. In some aspects, the techniques described herein relate to a method, further including: storing the generated listing in the database; assigning a user profile to the generated listing; determining a listing value for the generated listing based on data including comparative sales tracking and data indicative of behavioral patterns; convert listings to sales listings compatible with one or more sales channels, wherein the one or more sales channels includes a formatting and pricing requirement; and synchronize listing availability and inventory data across the one or more sales channels based on detected sales activity. In some aspects, the techniques described herein relate to a method, wherein synchronizing listing availability and inventory data across the one or more sales channels based on detected sales activity further includes: detecting a completed sale transaction for a particular item on any one of the one or more sales channels; and automatically update an availability status of the particular item across all other of the one or more sales channels to reflect the sale. In some aspects, the techniques described herein relate to a method, further including: notifying the user of a change in the availability status.

In some aspects, the techniques described herein relate to a method including: receiving data corresponding to a physical collectible item, the data including at least one of an image, text, or audio; identifying the physical collectible item by applying a trained machine learning model on the received data to extract one or more features of the physical collectible item; retrieving one or more historical and/or real-time transaction records associated with the identified physical collectible item from at least one external data source and at least one internal inventory database; generating a pricing guidance for the physical collectible item by applying one or more machine learning models trained to identify sales trends, behavior patterns, seasonal fluctuations, and market anomalies to the retrieved one or more transaction records and output pricing guidance; linking the pricing guidance to the physical collectible item; and storing the linked pricing guidance with data corresponding to the physical collectible item in a database.

One or more of the following features can be included in any feasible combination. In some aspects, the techniques described herein relate to a method, wherein the pricing guidance includes one or more of: an estimated current market value, a pricing range across different sales channels and a time-based recommendation on whether to sell or hold the physical collectible item. In some aspects, the techniques described herein relate to a method, further including: detecting a material change in the pricing guidance for the physical collectible item; and notifying a user associated with the physical collectible item of the material change in the pricing guidance. In some aspects, the techniques described herein relate to a method, wherein the data corresponding to the physical collectible item includes at least one of a photographic image, a textual description, keywords, metadata, a machine-readable barcode, a QR code, or a recorded voice annotation. In some aspects, the techniques described herein relate to a method, wherein the database is configured to synchronize on a periodic basis with at least one external structured data source, the external structured data source including at least one of a manufacturer-maintained product database, a third-party online marketplace catalog, and a user-generated public index, and wherein synchronization includes ingestion of one or more of item metadata, pricing information, and/or classification attributes. In some aspects, the techniques described herein relate to a method, wherein the data corresponding to the physical collectible item includes at least two of the photographic image, the textual description, keywords, metadata, the machine-readable barcode, the QR code, or the recorded voice annotation. In some aspects, the techniques described herein relate to a method, wherein the trained machine learning model is associated with a confidence score indicative of the confidence that the retrieved transaction records are associated with the physical collectible item. In some aspects, the techniques described herein relate to a method, wherein generating the pricing guidance further includes: detecting fluctuations in a value of the physical collectible item based on the retrieved historical and/or real-time transaction records; and by applying a temporal weighting factor.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

FIG. 1 illustrates a system block diagram for implementing a digital platform to support intake/acquisition of physical collectibles, valuation of the physical collectibles, and marketing of the physical collectibles via physical sales channel(s), virtual sales channel(s) or a combination thereof, in accordance with some embodiments of the present disclosure.

FIG. 2 illustrates a method of acquiring, cataloging, and offering collectible cards for sale, in accordance with some embodiments of the present disclosure.

FIG. 3 illustrates a method of generating pricing guidance for collectible cards, in accordance with some embodiments of the present disclosure.

FIG. 4 illustrates a method of managing inventory across multiple sales channels in accordance with some embodiments of the present disclosure.

FIG. 5 illustrates a method of handling collectible cards purchased during a card break in accordance with some embodiments of the present disclosure.

FIG. 6 illustrates an example Breaking Feature Process, such as can be performed using and/or by a collectibles platform in accordance with some embodiments of the present disclosure.

FIG. 7 is a process flow diagram illustrating an example process for a collectibles platform in accordance with some embodiments of the present disclosure.

FIG. 8 is a process flow diagram illustrating a second example process for a collectibles platform in accordance with some embodiments of the present disclosure.

### DETAILED DESCRIPTION

The collectibles space is wide and often there are a number of similar products of a certain theme, character or other focus, from multiple sources and these sources may produce multiple variations of these collectibles that have different rarity/scarcity, value, etc. An example collectibles market is that has such variations is the collectible trading card market. In the sports trading card market, a particular player can be featured on multiple variations of playing cards that are distributed by a number of card manufacturers. Further, players are often playing across many years, so each year there are multiple variations of cards featuring the particular player that are released into the market. This results in a large number of unique trading cards that feature the particular player and can make proper identification and classification of a trading card that features the particular player extremely difficult without an undue amount of knowledge and experience. Additionally, there are often tribute or “throwback” trading cards that are similar to a past released card and it can be difficult to identify these cards and distinguish from the originally released card.

The difficulty of classifying collectible cards and the similarities between cards also makes the sale of such cards difficult, due to the large inventory that many card dealers carry. In many cases, the dealers may only list a small, curated collection of cards to sale through their online sales portals. However, the dealer is likely to have a large number of cards that don't get listed in such a manner due to various factors, such as a lower value of a particular card, difficulty of listing and maintaining a large card inventory on digital and/or physical sales channels, and/or other factors. Because of this, card dealers may be losing out on potential sales of such cards due to various complexities, such as the aforementioned.

A growing activity in the collectibles space is breaking, such as trading cards breaking. Many collectibles come in packaging that may obscure or obfuscate the identification of the collectible, which can add randomness and/or anticipation to the opening of the collectible. “Breaking” in the trading card space is a growing activity that involves the opening of card packs, boxes or cases on a live video stream. Participants, such as consumers, claim or are assigned particular allocation criteria and will receive trading cards from the breaking activity that align with this criteria. For example, a participant may be allocated all cards from the break that are associated with a particular team. After the “break” has been completed, the participant will receive the physical cards from the event that aligned with their criteria. However, in many cases, there are likely to be cards that participants receive but do not want, and are now stuck with.

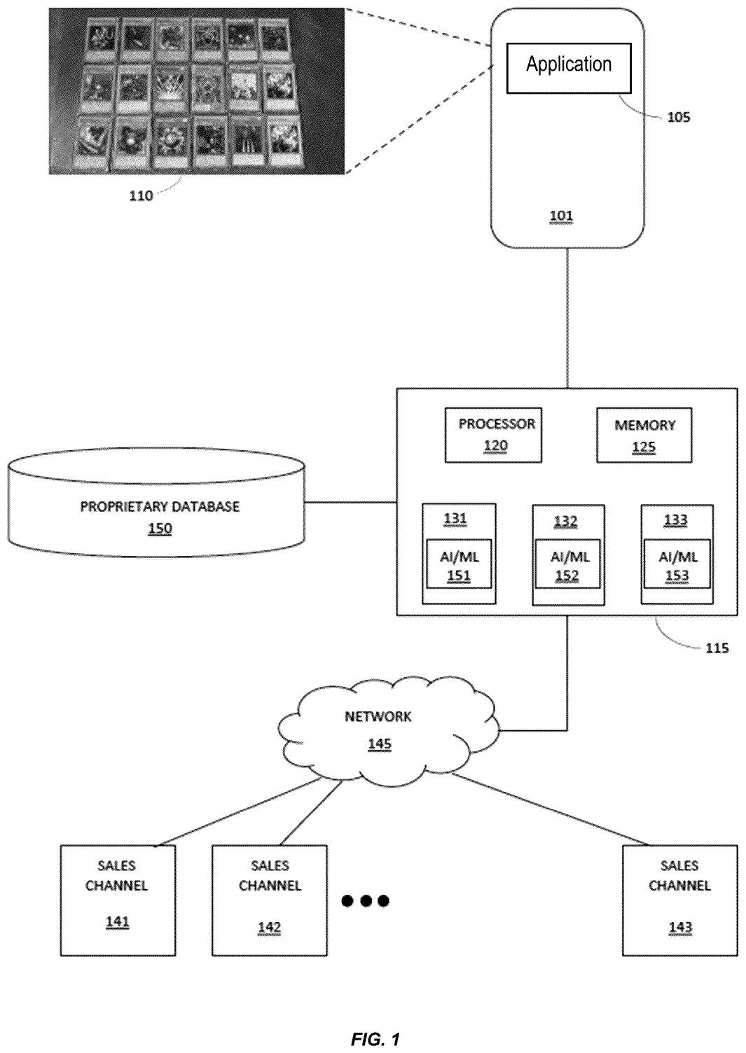

FIG. 1 illustrates a system block diagram for implementing a digital platform to support intake/acquisition of physical collectibles, valuation of the physical collectibles, and marketing of the physical collectibles via physical sales channel(s), virtual sales channel(s) or a combination thereof. The system shown in FIG. 1 is described in the context of collectible cards. However, this system (or other similarly configured system) can be used to support intake, acquisition, and marketing of other physical collectibles including comics/manga, coins, vinyl records, figurines, toys and the like. In some cases, the system can also implement other functionality, as discussed below.

The example system includes a smart phone 101 that executes an application 105. A user, such as a dealer or seller of collectible cards, uses the app 105 to scan or capture images of one or more collectible cards 110, e.g., using the camera integrated into the smartphone 101. The images captured by the smart phone 101 are transferred to a computing system 115 that implements at least one processor 120 and at least one memory 125 for storing information representative of the images. In the interest of clarity, the computing system 115 shown in FIG. 1 is depicted as a single entity having a single processor 120 and a single memory 125. However, the computing system 115 can be implemented in other architectures such as a distributed computing architecture or a cloud computing architecture.

The computing system 115 executes one or more modules for implementing specific functionality. For example, the module 131 implements functionality related to the intake of physical collectibles such as the collectible cards 110, the module 132 implements functionality related to the valuation of the physical collectibles, and the module 133 implements functionality related to marketing, buying, and selling the physical collectibles through different sales channels including the sales channels 141, 142, 143 shown in FIG. 1. The computing system 115 communicates with the sales channels 141, 142, 143 via one or more networks such as the network 145.

The module 131 analyzes images of the collectible cards 110 to identify and categorize the cards in the image. If there are multiple cards in the image of the collectible cards 110, the module 131 identifies the different cards and then processes each individual card separately, concurrently, or in parallel. In addition to image recognition, the platform can also intake inventory through a variety of other methods includes speech and/or text. In an example, a user can vocalize information from the card (e.g., name of the player, year, product and/or brand), which can be captured by a microphone or other acoustic input device, such as included on the smart phone 101. The captured acoustic information is processed to recognize the provided information which can be used to find a match within a canonical catalog of the platform and identify the card. In another example, a user can capture or input text on the card, or portion thereof, such as by using an image capture or text input device. The provided textual information is processed and used to find a match within the canonical catalog. Note, the described processing of image, voice and/or text data can be performed by the computing system 115, smartphone 101, or a combination thereof.

The canonical catalog associated with the platform includes information regarding various collectibles, such as trading cards. The information includes information about various features and/or characteristics of the collectibles. For example, for trading cards, the canonical catalog can include information regarding individual trading cards, such as identification of the subject of the trading card, manufacturer of the trading card, year associated with the trading card, textual and graphical information contained on the trading card, an image of the trading card, and/or other information related to the trading card. During a collectible identification process, information input to the platform regarding the collectible, such as image, speech and/or text input(s), is used to identify a match within the canonical catalog, thereby identifying the collectible in question. In an example embodiment, the canonical catalog, or portions thereof, can be stored in the proprietary database 150, other elements of the platform 101, accessible remote storage (e.g., cloud storage), and/or combination(s) thereof.

The canonical catalog is iterative and can include various features and/or functionalities to assist with the ingestion of data into the canonical catalog. In an example, proprietary functionality can be included to access and gather collectibles data from various remote sources and import that information into the canonical catalog. As part of the data ingestion, the data can be processed to fit a predetermined data structure that is used by the canonical catalog. Alternatively, other data ingestion and processing techniques can be used to store the data in the canonical catalog. In some examples, the ingested data may be incomplete and the canonical catalog entry for a collectible can be completed with the currently available information. As additional data is ingested related to the collectible, the canonical catalog entry for the collectible can be updated to include this information. In an embodiment, data in the canonical catalog can include a confidence score or indication that is representative of the perceived veracity associated with a particular data element. For example, data that is received from only a single source can be assigned a low confidence indication and if data from other sources corroborates the data, the confidence indication can be increased. Similarly, data from a new source may be assigned a low confidence until the data has been verified, such as by comparison to other sources, analysis by a confidence algorithm, manual review, etc. Once verified, the confidence indication associated with the data can be increased. Accordingly, in such embodiments, at least a portion of the data elements of one or more canonical catalog collectible entries can have an associated confidence indication. The confidence indication of a data element may not be communicated with users and used internally only. Alternatively or additionally, the confidence indication can be communicated with users, such as to encourage users to provide such information, correct information, corroborate the information.

In examples, a user can input information regarding a collectible into the platform in an attempt to identify and/or catalog the collectible and the collectible may not have an existing entry in the canonical catalog. In such examples, using the available information of the collectible that was input to the platform, the platform can use the data of the canonical catalog to assist with generating an identification of the collectible. In an embodiment, the user can be presented with one or more possible identifications of the collectible and the user can provide input indicating the correct or likely identification of the collectible. The platform can use various processes and/or algorithms to assist with generating the probable identification of the collectible. In an embodiment, the platform can use information from the entries in the canonical catalog to determine a probable identification of a feature of the collectible. For example, the user may provide an image of the collectible that includes a photo or illustration of a player. Using image analysis, the platform can identify or generate a probable identification of the player featured on the collectible. Alternatively, or additionally, textual data from the collectible can be analyzed to identify the player, such as by the player's name on the card. Other indicia on the collectible can be identified and used to generate an identification of the collectible, including statistics featured on the collectible, year information included on the collectible, indicia of a manufacturer of the collectible and/or other information from the collectible that is input to the platform. In this manner, even if a collectible does not have an entry in the canonical platform, the platform can provide a probable identification of the collectible and generate a new entry for the collectible within the canonical catalog. To assist with the identification process, AI/ML programming and/or processed can be used, such as to train a model that can be used to identify collectibles based on various indicia associated with a class or type of collectible and/or other features/characteristics associated with collectibles.

Additionally, a new canonical catalog entry can be generated for this collectible that did not previously have such an entry in the canonical catalog. The user can be prompted to provide additional information regarding the collectible to assist with completing the canonical catalog entry associated with the collectible, such as requested to provide various images of the collectible, input textual information that appears on the collectible, provide description(s) of the collectible and/or other information regarding the collectible. Additionally, or alternatively, other data sources and/or users can be queried for additional information regarding the new catalog entry. Further, the new entry can be incomplete and can be completed or additional information added thereto as that information is provided to or otherwise input to the platform.

When the platform attempts to identify a collectible that is not currently in the canonical catalog, the platform can still identify various features and/or characteristics of the collectible. The platform can use these various features and/or characteristics of the collectible to identify and catalog the collectible, present one or more likely identifications of the collectible, generate a new catalog entry for the collectible, and/or take other action(s) or combinations thereof. Using one or more algorithms, the platform can identify and catalog or provide one or more potential identifications of a collectible that is not in the canonical catalog. Using information from the input of the collectible, such as image, speech and/or text, the platform can determine the identification of the collectible or a potential identification of the collectible. In an example, an image of a trading card that is not included in the canonical catalog can be input to the platform. Using image analysis, such as by the AI/ML models trained and/or used by the platform, various information can be extracted from the image. The extracted information can include an identification of the player featured on the trading card, a manufactures trademark or indication, a style of the playing card that can be associated with a particular line of playing cards by a manufacturer, dates and/or statistical information included on the trading card, and/or other information included on the trading card that is present in the provided image(s). The algorithm(s) used by the platform can be trained on the included data in the canonical catalog and can be used in conjunction with the information extracted from the image of the trading card collectible to generate an identification or potential identifications. From this, the platform can generate a new catalog entry for the collectible in the canonical catalog.

Additionally, or alternatively, the platform can provide a series of questions or prompts to the user to assist with identification of a collectible. The user can then provide information to the platform through images, text and/or speech. Using this information, the platform can generate one or more potential identifications of the collectible and present these to the user. The user can be prompted to select one of the potential identifications. If the collectible is not currently in the canonical catalog, a new entry in the canonical catalog can be created that corresponds to the collectible. In an example, a user can provide input to the platform indicating that they would like to identify and, optionally, catalog a collectible. The platform can provide a prompt or series of prompts that requests information from the user regarding the collectible. The prompts can include fillable text boxes, an ability to upload an image, and/or present options to the user to select from. Based on the user responses to the prompt(s), the platform can generate an identification of the collectible in question. If the collectible is not already included in the canonical catalog, the platform can use one or more algorithms to generate a potential identification(s) of the collectible based on the provide information.

The module 131 automatically generates a listing for each of the cards and uploads the listing to a proprietary database 150. For example, if a collector arrives at a dealer's store with a box of collectible cards to sell, the dealer can use the app 105 on the smart phone 101 (or other imaging device) to scan batches of the collectible cards including the batch of collectible cards 110. For example, the set of collectible cards 110 may include cards used to play a tabletop role-playing game. The module 131 automatically identifies the game, the actions or characters represented by each card, and any other information that identifies the card or distinguishes one from another. In some cases, the module 131 also categorizes the cards by their physical condition, e.g., grading the cards according to industry standards. The module 131 then creates a listing including images of the card and the information associated with the card that was generated by the module 131. In some cases, information included in purchase orders or receipts associated with one or more of the collectible cards 110 can also be scanned by the app 105 (or entered manually) and added to the listing. The listing is then stored in the proprietary database 150. Listings for each dealer are associated with dealer profile and can be accessed by the dealer, e.g., by logging into the computing system 115 via the application 105.

Some implementations of the module 131 include (or are associated with) an artificial intelligence (AI)/machine learning (ML) module 151 that is trained to perform operations associated with intake or acquisition of physical collectibles such as the collectible cards 110. For example, the AI/ML module 151 can be trained to grade the quality of the collectible cards 110 according to industry standards. Training of the AI/ML module 151 can be performed using listings in the proprietary database 150 for cards that have been manually graded or using third-party databases. For another example, the AI/ML module 151 can be trained to identify variations between cards, which can be crucial to valuing a particular card. The AI/ML module 151 can be trained to tag the collectible cards 110 to indicate the detected variations. The AI/ML module 151 can also identify the subject matter of the card and classify the card even when a particular variation cannot be correctly or unambiguously identified.

The module 132 estimates the value of the cards in the set of collectible cards 110. In some cases, the module 132 accesses pricing or sales information from one or more external sources such as the sales channels 141, 142, 143. Examples of sales channels 141, 142, 143 include a point-of-sale (POS) device in the dealer's store or at a conference or show, an online auction site such as eBay, or an online shopping site such as Shopify. For example, the module 132 may use information from the sales channel 141 to determine that a card sold for $10 in the dealer's store, information from the sales channel 142 to determine that the card sold for $11 on eBay, and information from the sales channel 143 to determine that the card sold for $12 on Shopify. The module 132 may then provide pricing guidance such as a range of $10-$12, an average such as $11, pricing guidance specific to the different sales channels 141, 142, 143, or pricing guidance determined based upon another algorithm.

The module 132 may also provide pricing guidance associated with different time intervals such as date, time of day, season, etc. Information associated with the card (or similar cards) in the proprietary database 150 may also be used to determine the pricing guidance for a card. For example, the proprietary database 150 may include historical sales information for the card (or similar cards) and the historical sales information can be used to generate the pricing guidance. For example, the platform can inform a dealer that prices for cards in a particular genre have historically had a higher price at a particular time of the year. The pricing guidance can be provided to the dealer via the app 105.

In some cases, the pricing guidance is determined based upon grading information associated with the collectible cards 110. Cards that are in better condition, and therefore receive a higher grade, typically command much higher prices than cards that are in worse condition and receive a lower grade. Grading can be performed by third-party companies or, as discussed above, the AI/ML module 151 can be trained to automatically grade the collectible cards 110 upon intake.

The module 132 can provide dynamic pricing information, e.g., by automatically updating the pricing guidance multiple times every day. For example, the module 132 may scan sales or pricing information associated with cards in the proprietary database 150 multiple times a day and use this information to detect any dynamic changes in the pricing of cards in the inventories of dealers. The dealers can then be notified in response to these changes. For example, if the module 132 detects an increase in the asking or sales price of a card, dealers who have that card in their inventory are notified so that they have an opportunity to offer the card for sale and take advantage of the increased price. Conversely, if the module 132 detects a decrease in the asking or sales price of a card, dealers are notified to give them the opportunity to purchase the card at a discount. In some cases, dealers can configure profiles that determine the conditions under which the module 132 provides a notification of a price increase or decrease.

In some cases, the module 132 includes an AI/ML module 152 that is trained to identify patterns in sales or pricing information. The AI/ML module 152 can be trained using historical pricing information from the proprietary database 150 or from the sales channels 141, 142, 143, or from other third-party sources. The AI/ML module 152 provides personalized recommendations to dealers or sellers based on patterns detected in the sales or pricing information. For example, the AI/ML module 152 may detect a pattern indicating that the value of baseball cards for teams that participated in the World Series increases while these teams are in spring training. Dealers who actively trade in baseball cards may therefore be notified so that they can purchase cards for these teams prior to spring training and then offer them for sale during spring training. The AI/ML module 152 may be able to detect or identify communities or categories of people that are likely to purchase certain cards or categories of cards. For example, the AI/ML module 132 can identify groups that collect cards associated with a particular baseball team so that dealers can market cards associated with this team to these groups.

In an embodiment, the processing of the input data, such as an image of a collectible, can be performed by the computing system 115. Alternatively, the processing can be done on a user device, such as the smartphone 101 that includes the application 105. In a further alternative, the processing can be performed using an external resource, such as a cloud computing platform, or by a combination of the discussed. Similarly various operations, functions and/or features of the platform can be performed by distinct elements of the platform or shared by elements of the platform.

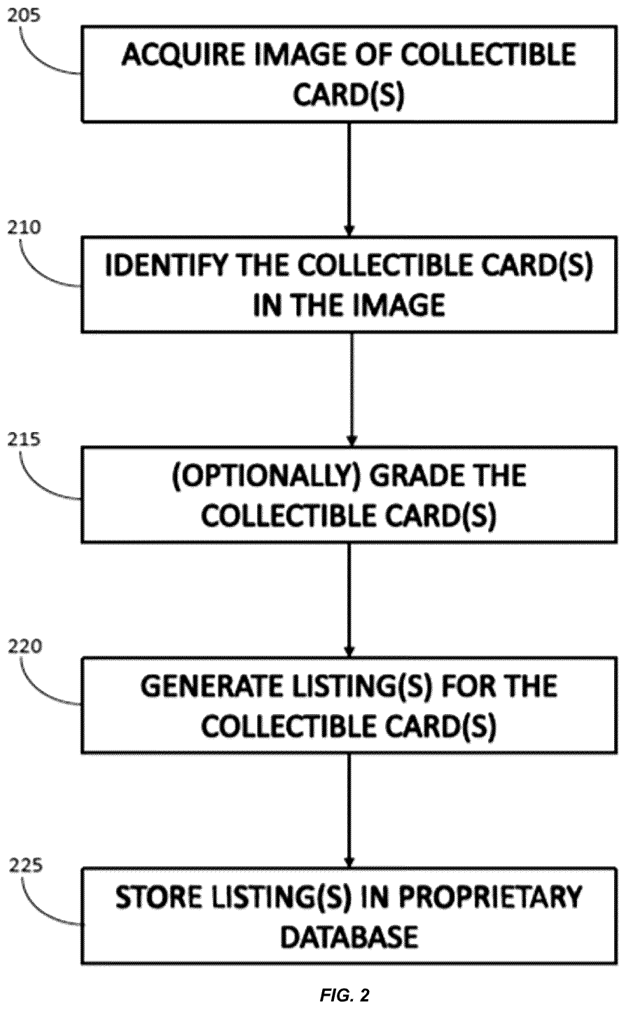

FIG. 2 illustrates a method of acquiring, cataloging, and offering collectible cards for sale. The method can be implemented in the system illustrated in FIG. 1. Although the method of FIG. 2 is described in the context of collectible cards, this method can also be used for other physical collectibles.

At step 205, an image of one or more collectible cards is acquired using an imaging device. Additionally, or alternatively, other input means can be used, such as text or speech, to provide information regarding the collectible card as discussed previously. For example, a dealer can use their smart phone to scan or photograph a set of cards that has been offered to the dealer for possible purchase. The dealer can scan the front of the cards, e.g., the side of the cards that includes an image of the person or entity represented by the card, or the dealer can scan both the front and back of the cards. The back of the card typically contains a verbal description of the person or entity, statistical information related to the person or entity, a numerical description of the person or entity, or other information.

At step 210, a computing system identifies the collectible cards that are represented in the image. In some cases, the collectible cards are identified by matching the image of the person or entity represented by the card with a reference database of cards, either in a proprietary database or using third-party reference materials. An AI/ML module can be used to categorize or identify cards, such as cards that are not found (or not correctly or unambiguously identified) in the proprietary database or the third-party reference materials.

At the optional step 215, the computing system may grade the collectible cards using an AI/ML module that has been trained to evaluate the condition or quality of cards. The

AI/ML module is trained using information in the proprietary database, examples of graded cards from third parties, or other information.

At step 220, the computing system generates listings for the collectible cards. The listings can include information identifying the person or entity represented by the card, a verbal description of the person or entity represented by the card, numerical or statistical information associated with the person or entity represented by the card, information indicating the maker or publisher of the card, a manufacture date of the card, and other relevant information. If available, e.g., from the optional step 215 or from a third-party grading agency, grades for the cards are added to the listings for the cards.

At step 225, the listing is stored for subsequent use, e.g., in the proprietary database. In some cases, listings for one or more of the collectible cards may already be present in the proprietary database, e.g., if one or more previous owners of the collectible card also used this system for inventory management. In that case, the proprietary database can link the listings and generate an ownership history, or provenance, for the collectible card.

The module 133 supports inventory management and sales of physical collectibles via the sales channels 141, 142, 143. The different sales channels 141, 142, 143 have different policies for listing items for sale, different language requirements, different rules for the number of words in a product summary, different formatting, and other variations in how listings are presented. To list a collectible item for sale on multiple channels, the module 133 accesses a listing for the collectible item from the proprietary database 150 and then translates or reformats the listing based upon the policies, language requirements, rules, formatting requirements, etc. for the sales channels 141, 142, 143. A dealer or seller can therefore list an item for sale on the sales channels 141, 142, 143 with a single click via the app 105.

The module 133 also automatically adjusts the prices of the cards listed for sale based on channel-specific characteristics such as shipping costs or fees. For example, if the dealer sets the base price of a collectible card at $10, the module 133 can automatically adjust the price on the sales channel 141 upwards to $11 if the sales channel 141 charges a one-dollar fee for the listing. Similarly, the module 133 can automatically adjust the price on the sales channel 142 upwards to $12.50 if the sales channel 142 charges $2.50 for shipping the card to the buyer.

The module 133 can also use the information in the proprietary database 150 to recommend listing different collectible cards (or genres of collectible cards) on subsets of the sales channels 141, 142, 143. For example, information in the proprietary database 150 may indicate that NFL cards typically sell at a premium on sales channel 142 during the two weeks prior to the Super Bowl, which may lead to a dealer holding their most valuable cards off the market until this time window and then preferentially listing them for sale on the sales channel 142 in the two weeks leading up to the Super Bowl. In some cases, the AI/ML module 153 is trained to identify buying or selling patterns on the sales channels 141, 142, 143. The AI/ML module 153 can be trained using sales or pricing information in the proprietary database 150, from the sales channels 141, 142, 143, or using other third-party information.

The module 133 coordinates inventory management across physical and virtual sales channels 141, 142, 143. For example, the module 133 automatically removes listings of a card (or reduces the quantity of cards available for sale) on the channels 142, 143 in response to information indicating sale of the card on the sales channel 141.

As discussed above, the computing system 115 identifies and categorizes the collectible cards 110 into groups that are indicated by their SKU. However, slight variations are often discernable between the different cards within the category covered by each SKU. These variations may be important to some buyers and these buyers may prefer to choose a specific card from within a set of cards that are in a category associated with an SKU. For example, an SKU may be assigned to the 1986 Michael Jordan Fleer rookie card and a dealer may have multiple copies available. However, collectors can be very discerning and some may prefer to choose what they believe is the “best” example of the card from among the available cards. In some cases, the module 133 can therefore implement inventory management techniques that allow buyers to purchase a specific card within a SKU, which requires systems for coordinating physical and virtual sales channels to prevent multiple sales of the same card within a SKU category.

The proprietary database 150 can be used to identify buyers (or communities of buyers) within the collectibles ecosystem that are interested in purchasing specific categories of collectible cards. The AI/ML modules 151, 152, 153 can be used to identify buyers or groups of buyers that are interested in specific collectible cards or categories of cards, as well as identifying the time windows and sales channels 141, 142, 143 for reaching these buyers or groups of buyers. For example, the AI/ML module 153 can be trained on data in the proprietary database 150 to identify buying patterns from historical sales data associated with the listings or profiles of cards in the proprietary database 150. The AI/ML module 153 can then alert dealers based on these buying patterns.

Fintech products can also be constructed based on physical collectibles such as the collectible cards 110. For example, the computing system 115 can learn the value of a collectible card (or set of cards), as discussed herein. The computing system 115 can then use the collectible card (or set of cards) as collateral on a loan provided to the owner of the card(s). The value of the loan would correspond to the value of the collectible card (or set of cards). The valuations determined by the computing system 115 can also be used to provide liquidity or working capital to dealers, e.g., leveraging the value of the collectible cards in a dealer's inventory to provide capital that allows them to purchase additional cards for subsequent sale. The valuations determined by the computing system 115 can be used to provide insurance products for the owners of physical collectibles.

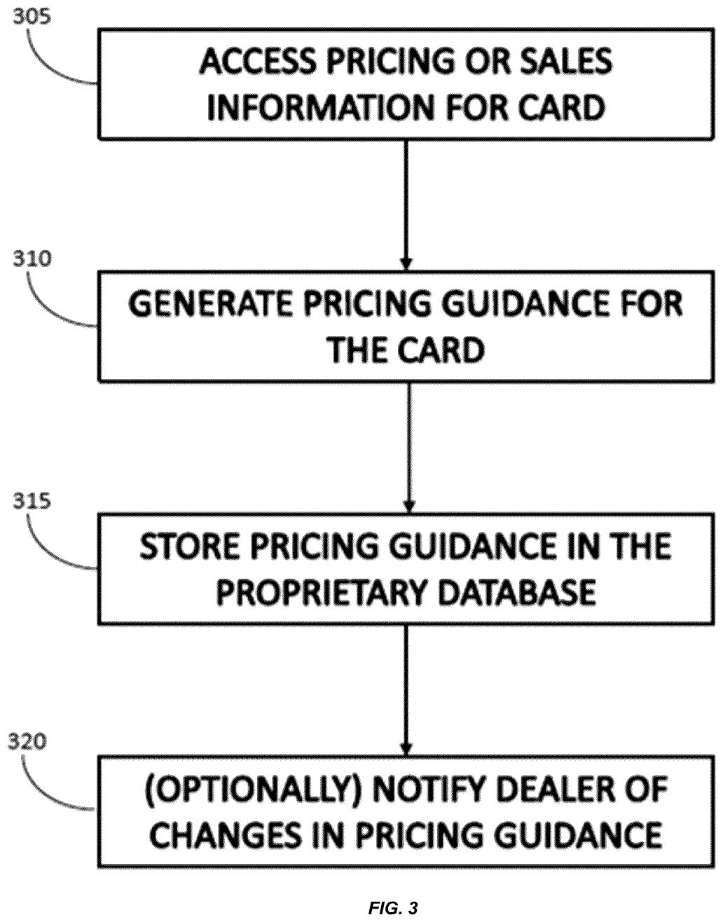

FIG. 3 illustrates a method of generating pricing guidance for collectible cards. The method can be implemented in the system illustrated in FIG. 1. Although the method of FIG. 3 is described in the context of collectible cards, this method can also be used for other physical collectibles.

At step 305, the system accesses pricing or sales information for the collectible card. Accessing the pricing or sales information includes scanning or accessing information indicating the sale price of cards sold through sales channels such as eBay or Shopify or Sotheby's or a POS system used in a shop, conference, or tradeshow. For example, the system may access records of all the sales of collectible cards through a sales channel over the past 12 hours. The collectible cards in these records are then matched up with collectible cards in the proprietary database. The price histories of the matching cards are then updated with the latest sales information. Scanning for the new sales information can occur periodically, substantially continuously, in response to a user request, or in response to some other event. For example, the system may scan for new sales information twice a day.

At step 310, the system generates pricing guidance for one or more cards in the proprietary database. In some cases, new pricing guidance is generated in response to new sales information being added to the listing for the card during the last iteration of the scanning process. Generating the pricing guidance for the card is performed according to a predetermined algorithm such as updating the suggested price for the card to the most recent price, averaging the retrieved card prices over a predetermined time window such as a week, or using other algorithms. Different pricing guidance may also be generated for different sales channels.

At step 315, the latest pricing guidance is stored in the proprietary database. Dealers can then access the pricing guidance before offering their collectible cards for sale.

At the optional step 320, the system can notify the dealer in response to the system detecting changes in the pricing guidance for one or more collectible cards. For example, the system can notify the dealer in response to detecting a decrease in the price of one or more collectible cards, which may give the dealer an opportunity to purchase additional cards for their inventory at a reduced cost. For another example, the system can notify the dealer in response to detecting an increase in the price of one or more collectible cards, which may give the dealer an opportunity to offer cards in their inventory for sale at an increased price. Dealers can configure the events, thresholds, or other conditions under which the system generates a notification in response to changes in the pricing guidance.

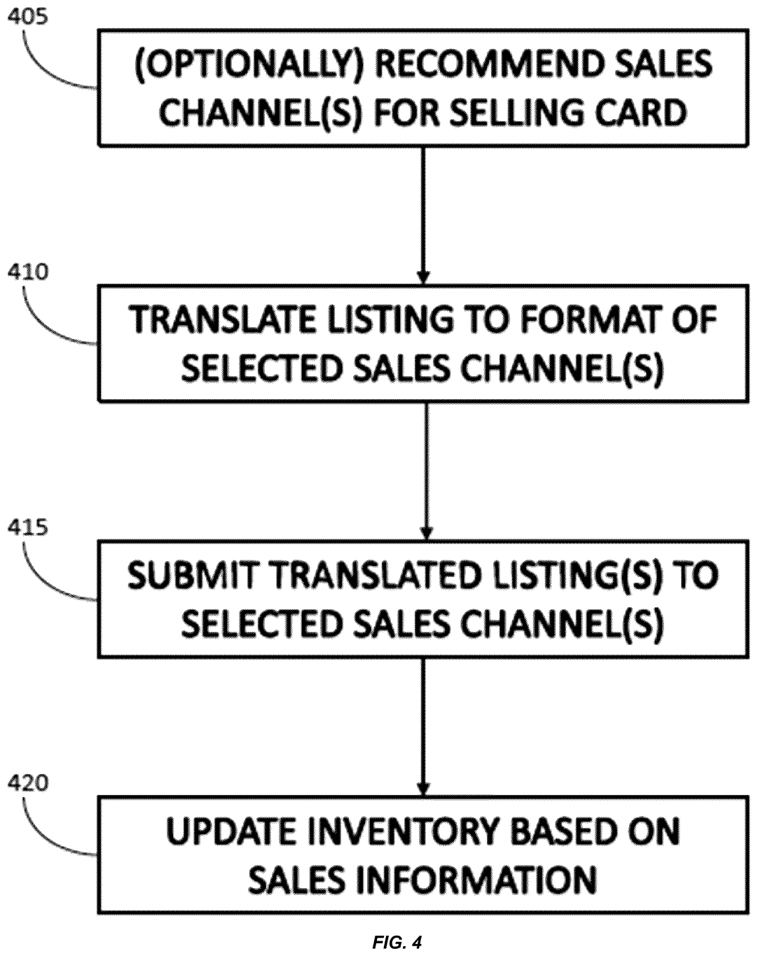

FIG. 4 illustrates a method of managing inventory across multiple sales channels. The method can be implemented in the system illustrated in FIG. 1. Although the method of FIG. 4 is described in the context of collectible cards, this method can also be used for other physical collectibles.

At the optional step 405, the system recommends a subset of the available sales channels for selling one or more cards. For example, the system may recommend offering some cards for sale on eBay and other cars for sale on Shopify. The sales recommendation can be determined based on information acquired from the sales channels, such as information indicating high or low demand for a card or category of cards, information indicating increasing or decreasing prices for a card or category of cards, or other information. In some cases, an AI/ML module is trained to recommend sales channels. Training of the AI/ML module is performed using information such as historical sales information from the proprietary database or third-party sources. The AI/ML module can identify subtle patterns in the buying, selling, and pricing of the collectible cards and use these patterns to identify preferred sales channels. For example, the AI/ML module can identify patterns indicating that demand for a card or category of cards is higher or lower at certain times of day, certain days of the week, or certain weeks in the year.

At step 410, the system translates the listing for the card to the formats of each of the selected sales channels. The format of a sales channel is determined based on the policies, language requirements, and other formatting information set by the owner of the sales channel. For example, the sales channel may set a word limit on summaries of the products that are offered for sale on the channel. The system therefore modifies the summary description of the collectible card to conform to the word limit before sending the listing to the sales channel. In some cases, translating the listing for the card includes modifying the offered price based upon fees collected by the sales channel. For example, the system can use information indicating shipping costs, platform fees, and the like to modify the offered price before sending the listing to the sales channel.

At step 415, the system submits the translated listings to the selected sales channels. Once the sales channels confirm that the listings have been made public, the system monitors the sales channels to detect information, signaling, or messages indicating sales of the collectible cards that are listed.

At step 420, the system updates the dealer's inventory records based on sales information received from the sales channels. For example, if the dealer has ten copies of a collectible card available for sale on two virtual sales channels and in the dealer's store, the system automatically reduces the inventory count by one each time a card is sold in one of the virtual sales channels or in the dealer's store (as indicated by information from the POS system in the store). Notifications may also be provided to the dealer (or other employee) in response to virtual sales so that copies of the collectible card can be removed from displays in the store, if necessary. The computing system shown in FIG. 1 can be modified to support automatic intake, valuation, and sales of cards acquired by a dealer or seller during a live streamed card break. For example, if a participant has bought into a card break, the participant has paid a fixed amount of money that entitles them to receive cards in a predetermined category of card, should the cards in that category be found within the pack, set, or box of cards that is being broken. The participant may be interested in selling high-value cards from the break directly to a remote buyer. In that case, the computing system 115 accesses the live stream and uses the images in the stream to identify the cards that are won by the dealer in the break, adds them to the dealer's inventory (as discussed above), determines a valuation for the cards (as discussed above), and then lists the cards for sale on one or more of the sales channels 141, 142, 143 (as discussed above) including within the existing break. If the cards from the break are purchased via the sales channels 141, 142, 143, the participant (or the computing system 115) can instruct the person or organization that is running the card breaking event to transfer ownership of the card to the buyer and send the card directly to the buyer, thereby simplifying the process and saving unnecessary shipping charges.

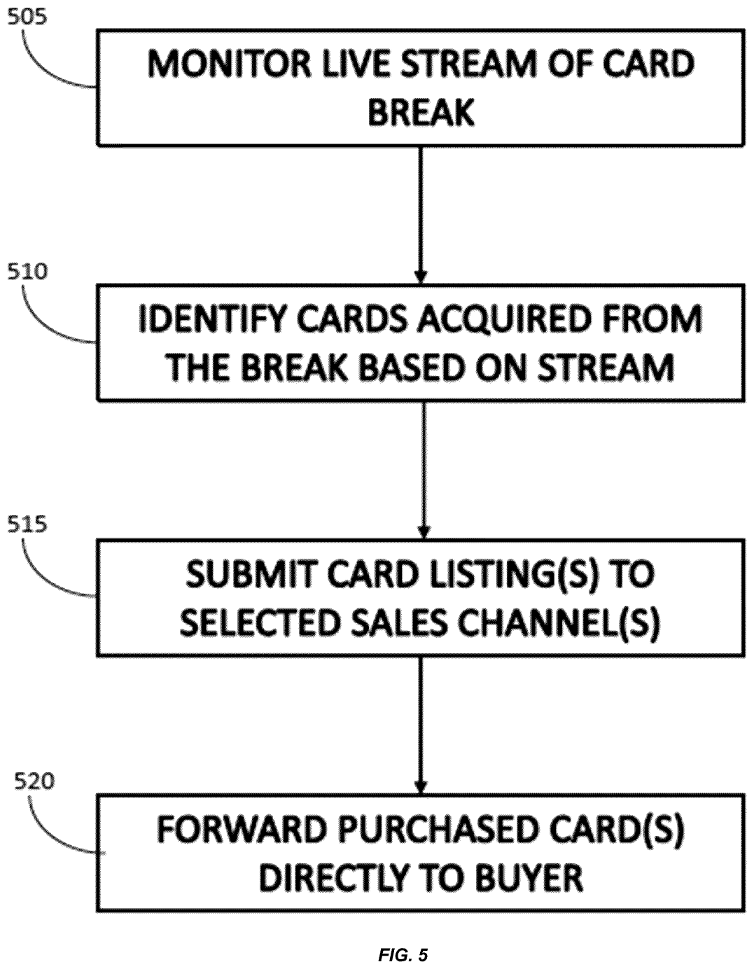

FIG. 5 illustrates a method of handling collectible cards purchased during a card break. The method can be implemented in the system illustrated in FIG. 1. Although the method of FIG. 5 is described in the context of collectible cards, this method can also be used for other physical collectibles.

At step 505, the computing system monitors images in a live stream of a break. For example, instead of using a smart phone to provide images of collectible cards, the images are acquired by identifying cards as they are revealed in a live stream of a card break. The images in the live stream may be captured using one or more cameras in a studio. As discussed herein, the dealer has purchased the right to acquire cards of a particular category that may be revealed during the card break.

At step 510, the computing system identifies cards acquired from the break by the dealer based on the images in the live stream. The computing system determines whether each revealed card is in the category purchased by the dealer and, if so, the computing system adds the card to the dealer's inventory, e.g., as described herein with regard to FIG. 2. In some cases, the computing system determines pricing guidance for the card, e.g., as described herein with regard to FIG. 3.

At step 515, the computing system submits the card listings for the acquire cards to one or more sales channels. In some cases, the computing system selects a subset of the available sales channels and submits the cards to the sales channels, e.g., as described herein with regard to FIG. 4.

At step 520, the computing system determines whether one or more of the acquired cards have been purchased via the sales channels. If so, the computing system (or the dealer) instructs the person or organization that presented the card break to forward the purchase cards directly to the buyer that purchased the card via the sales channels. For example, the computing system can acquire a mailing address from the user during the purchasing process on the sales channel. The computing system can then forward the mailing address with permission (or other indication that the buyer has legally acquired the card) to the person organization that presented the card break. Thus, resale of cards acquired during a break is performed seamlessly and without unnecessarily shipping the card to the dealer and then from the dealer to the buyer.

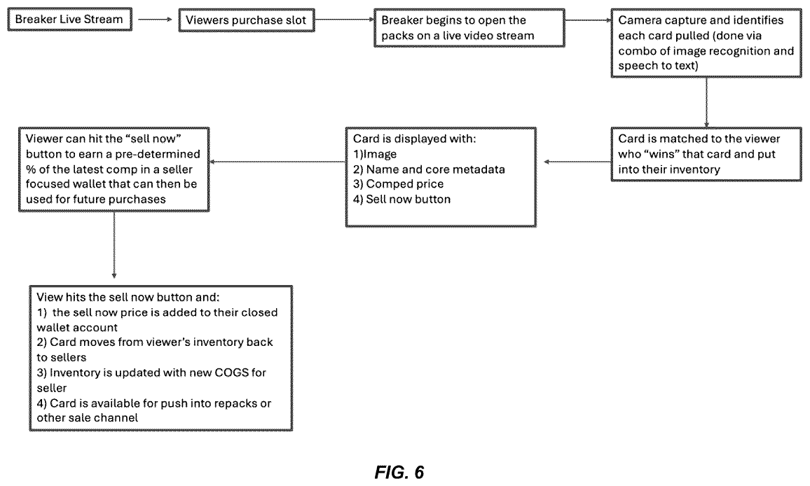

FIG. 6 illustrates an example Breaking Feature Process, such as can be performed using and/or by a collectibles platform. In an example embodiment, the collectibles platform can manage and facilitate the break, such as tracking the participants and their break criteria, providing a broadcast of the break to the participants, facilitating communication between the participants and/or with the breaker, and/or other aspects of the breaking process.

A break is the opening of one or more card packs, with the participants paying into the break to receive cards. Participants can purchase a slot to participate in the break and the slot can be random or for a specific team, sport or other criteria. In the random breaks, a participant will be randomly assigned a team or other criteria for the break and receive the cards that are aligned with that criteria, such as all of the cards of a specific team. In other breaks, the participant will receive cards based on the criteria that they purchased to participate in the break. Participants may purchase slots for the break in advance of the break occurring or may do so right before the break actually occurs. The unknown nature of the cards that will be distributed as a result of the break increases the anticipation of the participants, as the cards a participant receives may be of higher value than the cost of the purchased slot.

The break is broadcast, such as over a livestream through an online video service or portal (e.g., collectibles platform, YouTube, Twitch, etc.). The broadcasting of the break allows the participants to review the cards as they are revealed and increases the communal aspects of the break process. Additionally, during the livestream of the break, users may be permitted to communicate with each other and/or with the person performing the break, further increasing the communal nature of the activity.

The platform can receive the broadcast and analyze the video stream to identify the cards pulled during the break. As cards are revealed in the broadcast, the platform can automatically add or assign the revealed cards to individual participant's collections based on their break criteria (e.g., associated team(s), etc.). In this manner, the break cards that are to go to a particular participant are automatically added to that participant's card collection inventory of the collectibles platform. This allows the participant to have a real-time inventory of their card collection and the participant can gain additional information regarding the cards they receive through the break, such as rarity, pricing and/or other information. Similarly, the participants may also be provided an overview of the break as it occurs, indicating the cards that were revealed, the identification of a participant associated with each revealed card, pricing information of each revealed card, rarity information of each card and/or other information regarding each of the revealed cards. Additionally, the information regarding the cards revealed during the break can be aggregated to provide a comprehensive overview of the break as it occurs, such as the number of cards left to be revealed, odds of revealing certain cards, etc.

As noted above, as cards are revealed during the break, they can be automatically (semi-automatically or manually) assigned to each participant based on each participant's break criteria. The assignment of a revealed card of the break causes the card to be added to the participant's inventory maintained on the platform. In an example, during the break, each participant may be provided a view or list of cards that were assigned to them during the break. In this manner, the participant can quickly view the cards that they have received during the break without having to view or filter their complete card inventory.

For each card received during the break, the participant can be presented an option to sell back the card to the entity performing the break. This option can be associated with each individual card that the participant receives and/or is assigned during the break based on their criteria. The platform can automatically assign a monetary value associated with each card and that is the value the participant will receive for “selling” a card received during the break to the entity that is performing the break. The platform can automatically assign a value to a card based on the market price, such as a portion of an average sale price of a particular card within a time period. For example, the platform can assign the price of a particular card as a portion of a recent average sales price of the same card, and the average sales price can be aggregated from multiple sources or taken from a single source. In a further example, the entity performing the break can input settings to adjust automatic assignment of a price by the platform, such as setting the portion of an average sales price, specifying sources used to determine the average sales price, providing specific prices for specific cards, other settings, or combinations thereof. The “sell back” settings can be globally set by an entity for all of their breaks or can be associated with individual breaks or groups of breaks. This settings information can be optionally presented to the participants prior to the break, as they may influence a participant's desire to participate in a certain break. For example, a breaking entity can indicate they are offering to buy back cards from the break at a greater portion of the average sales price than another breaking entity or from their usual portion of the average sales price. In other embodiments, the price received by a participant for a “sold back” card can be directly negotiated with the breaking entity using one or more communication channels through the platform, such as a private chat of the livestream, a messaging feature of the platform, etc.

When a participant selects the “sell back” option, the platform automatically credits the participant with the value of the card that is being sold back to the breaking entity, based on the various settings associated therewith. In doing so, the card can automatically be removed from the participant's inventory and added to the breaking entity's inventory on the platform. When this occurs, the breaking entity is no longer obligated to send the physical card to the participant, since the participant has sold the card to the breaking entity.

An alternative or further of the platform to allow a “break” participant to monetize the card(s) they received can include a sell, auction or similar feature. During the “break” a participant that would like to dispose of a card that they received can choose to offer the card to other participants of the “break.” A sell option can allow the participant to offer a selected card they received in the “break” at a set price to the other participants. The price can be input by the selling participant and the platform can provide guidance and/or recommended pricing that the selling participant can use or select a price for the card. The other participants can then be made aware of or notified that there is a card from the “break” that is for sale and can elect to purchase the card at the indicated price. Additionally, the listing of the card to the other participant can optionally include an offer feature, allowing the other participants to submit an offer to the selling participant for the card. The selling participant can the choose to accept or reject the offer from another participant. Alternatively, the selling participant can elect to provide the card to the other participants using only an offer feature and not provide a fixed price for purchase of the card. In another embodiment, the platform can include functionality to allow any participant in a “break” to submit an offer to another participant for a card they received in the “break,” i.e., an unsolicited offer. When a participant purchases the card, by direct purchase or offer, the card can be transferred to the buying participant's inventory and the “breaking” entity can disperse the physical card to the buying participant.

In another example, the platform can provide an auction functionality that a participant can use to monetize a card they received in the “break.” The selling participant can select to auction a card they received and the other participants can be notified or made aware of such. The other participants can then submit offers for the card in an auction format. The selling participant can specify a reserve price for the card or a no reserve auction. Based on the results of the action, the card can be transferred from the inventory of the selling participant to that of the buying participant and the “breaking” entity can be notified to disperse the physical card to the buying participant.

In example embodiments, the “breaking” entity can be allowed to participate in purchasing a card from a “break” participant through a direct sale or auction type process, such as described above. This type of sale can be different than a direct sale of a card back to the “breaking” entity, and in such situations, the “breaking” entity can be considered a participant in the “break.”

In a further example, when a participant wishes to sell a card to other participants using a sell or auction feature, the platform can make an automated announcement or notification in the livestream of the “break” to notify the other participants. Additionally, or alternatively, the breaking entity can be notified of the listing of a card by a “break” participant and can elect to make an announcement during the stream, as this can further increase participation of the “break” participants.

The funds received by the participant by selling back a card to the breaking entity or other “break” participant are deposited into an electronic wallet of the participant. The electronic wallet is maintained by the platform and the use of the electronic wallet funds may be limited by the platform. For example, the platform may limit the funds received by the participant for use with the breaking entity in future transactions, such as participation in future breaks, purchase of cards from the breaking entity, etc. In another example, the platform may allow the participant to use the funds with other entitles of the platform, such as other breaking entities. However, in doing so, the value of funds used for such by the participant may be reduced by the platform. Additionally, a breaking entity may allow participants to receive a cash (or equivalent) payout based on their electronic funds associated with the breaking entity in the participant's electronic wallet of the platform. The breaking entity may have various rules for doing so, including reducing the value of the received funds in response to the cash (or equivalent) payout. Further, in examples in which a participant sells a card to another participant of the “break,” the funds associated therewith can be sent to the selling participant as credit or currency within the platform, or as a cash/cash equivalent that can be deposited or withdrawn by the selling participant. In an embodiment, the terms and/or conditions regarding withdrawal of funds from the platform can be different for sales between “break” participants than those associated with sales between the “breaking” entity and a participant.

With the “sold back” card being automatically transferred or added to the breaking entity's inventory, the breaking entity can now list that card for sale through their sales channels. The listing of the card on the sales channels can be automatic, as configured by the breaking entity using the platform, or the breaking entity can manually add the card to one or more sales channels. The configuration of the automatic addition of a “sold back” card to sales channels can include a threshold value that would cause the card to be automatically added to the sales channels, the determination of a price of the card based on a source(s) of sales prices/price history, and/or other settings. This reduces the burden on the breaking entity to acquire and list cards that participant's do not want during the break.

Alternatively, the breaking entity may select to not automatically list the bought back cards through their sales channels. Rather, the breaking entity may choose to track the bought back cards and repackage the cards into repacks-collections of cards that can be sold for a set price. The platform can include tools and/or features to assist the breaking entity with assembling cards into repacks. The breaking entity can provide a target price or value for a repack and the platform can automatically recommend sets of cards that would fulfill this criteria. In an example, the breaking entity may select specific cards for inclusion in to repacks and the platform can automatically recommend other cards from the breaking entity's inventory that can be used to complete the repack(s) based on the criteria provided by the breaking entity. While this repack ability is discussed in regards to the breaking entity, other users of the platform can be provided a similar ability, such as card dealers, or other users who wish to sell portions of their collection.

Although a few variations have been described in detail above, other modifications or additions are possible. For example, in addition to the “sell back” capability, this invention can also be adapted to be a “Bid” option for other participants in the break, as discussed above. Using the pricing and rarity data provided, other participants can make the recipient of a card in a break an offer to buy the card and then their method of payment is charged immediately upon acceptance of the bid. This platform can provide or allow the selling party to set limited time windows to make the offer, offer specific types of payments and provide shipping to the eventual buyer.

In some implementations, the subject matter described herein provides technical advantages. For example, existing card cataloging platforms and services do not include an ability to automatically identify a particular card and instead rely on the user's correctly providing the identification of their own cards. These platforms and services do not have automatically evolving catalogs and often require manual intervention to add new cards or cards that are not already known to the system. Also, these platforms and services do not provide users with easy tools to assist with card identification. Additionally, the existing platforms and services are not a whole, integrated ecosystem. Rather, they are tailored for specific users/use cases, such as individual users or dealers. Further, these platforms and services are not connected with and receive information from multiple sources to assist with providing information regarding cards in user's inventories. This platform not only takes in images, but also speech to text and text fragments so that there are multiple ways to tying an individual asset to the canonical catalog.

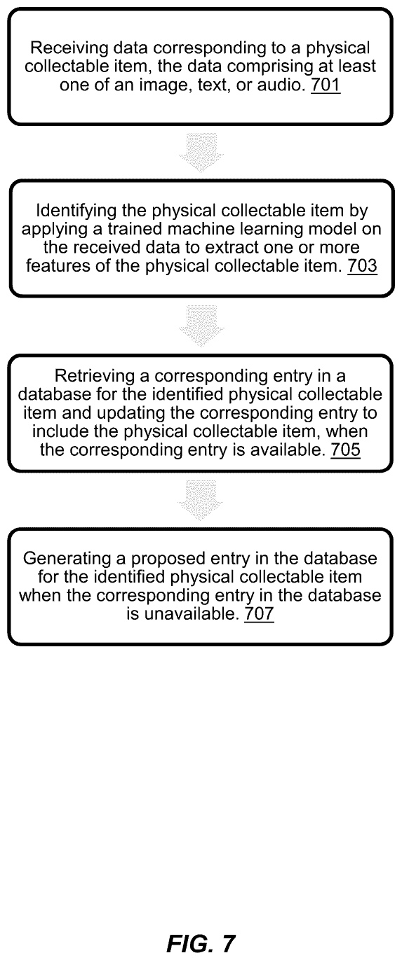

As shown in FIG. 7 a method in accordance with some embodiments of the present disclosure can include the steps of receiving data corresponding to a physical collectible item, the data comprising at least one of an image, text, or audio 701, identifying the physical collectible item by applying a trained machine learning model on the received data to extract one or more features of the physical collectible item 703, retrieving a corresponding entry in a database for the identified physical collectible item and updating the corresponding entry to include the physical collectible item, when the corresponding entry is available 705, and generating a proposed entry in the database for the identified physical collectible item when the corresponding entry in the database is unavailable 707.

For example, the data corresponding to the physical collectible item can include image, text, or audio 701 and can be generated by an application, such as an application on a smart phone or tablet. The data can be a photographic image, a textual description, keywords, metadata, a machine-readable barcode, a QR code, or a recorded voice annotation.

In some implementations, each entry in the database can include a confidence score. The confidence score may be indicative of or representative of the perceived veracity associated with a particular data element. When additional information is provided to the system, a confidence score of an entry in the database can be increased when the additional information is verifies or corroborates the information in the database.

In some implementations, the method may generate a proposed entry to the database for the physical collectible item when a corresponding entry is not found in the database, or a corresponding entry in the database is unavailable. Over time the system can receive additional information and data and the confidence associated with the proposed entry can be increased, as more verifying information is obtained. Once the proposed entry has a confidence score that surpasses a predetermined threshold the proposed entry can be converted into a permanent entry to the database.

In some implementations, the database storing the data and information regarding the physical collectible item can be configured to exchange and receive data and information from other sources. For example, the database can be configured to periodically synchronize with external sources of data such as a manufacturer-maintained product database, a third-party online marketplace catalog, and/or a user-generated public index. In some implementations, the database can receive data from the other external sources, including, but not limited to, item metadata, pricing information, and/or classification attributes.

In some implementations, a listing for the physical collectible item can be generated based on the corresponding entry in the database for the identified physical collectible item. As discussed above a listing may include images of the physical collectible item and information associated with the card. In some implementations, the listing may include a price or value that the physical collectible item can be exchanged for. In some implementations, the listing may include one or more parameters indicative of the physical collectible item or its value. Parameters of the listing may also include the format, pricing, and other descriptive elements of the listing. The parameters of the generated listing may be updated based on a rule set. A rule set may include audience behavior patterns, platform-specific fee structures and/or historical transaction velocity for items similar to the physical collectible items. The parameters of the generated listing may also be updated based on data and information received from a sales channel.

In some implementations, a process may include the further steps of storing a generated listing in the database, assigning a user profile to the generated listing, determining a listing value for the generated listing based on data that includes comparative sales tracking and data indicative of behavioral patterns. The process may also convert listings to sales listings that are compatible with different sales channels, as each sales channel may have their own formatting and pricing requirements. Listing availability and inventory can be synchronized across one or more sale channels based on the detected sales activity. For example, sales that are completed corresponding to a particular item in the database can be detected from the external sources and used to automatically update an availability status for that item across other sales channels and/or the database. In some implementations, the platform may notify the user of a change in the availability status (e.g., a collectible item is available or no longer available).

In some implementations, a system and/or method may include identifying and cataloging physical collectible items using artificial intelligence. In some implementations, this may include receiving, via a user-interface, input data describing a physical collectible item. For example, the input data may include at least one of an image, textual information or speech data. The input data can be processed using one or more machine learning models trained to extract identifying features or collectible items, including visual indicators, manufacturer metadata, and subject-related content. The extracted features can be compared to existing entries in a canonical catalog comprising previously cataloged collectible items. When a match is found, an existing catalog entry can be retrieved and associated with a user account. When no match is found, a provisional catalog entry can be generated using the extracted features, and by assigning a confidence score to one or more data elements within the provisional catalog entry. The resulting provisional catalog entry can be stored in an canonical catalog database. In some implementations, provisional catalog entry can be updated as additional corroborating data becomes available from external sources or user input.

As discussed herein, in some implementations, the input data can include a combination of at least two modalities selected from image data, textual descriptions, and spoken audio. Extracted features from data corresponding to each of the two or more modalities can be fused to improve the accuracy of the identification process. In some implementations, a fallback heuristic can be utilized when the machine learning or artificial intelligence based model has a confidence level that falls below a threshold. For example, when the machine learning model assign a confidence score below a predefined threshold to a provisional catalog entry, the system may apply a fallback heuristic based on manually curated feature rules to attempt to match the collectible item to an existing catalog entry. In some implementations, data from third-party market sources can be used to automatically update the database or catalog. For example, the platform can be configured to monitor and parse third-party online marketplaces for listings corresponding to provisional catalog entries, and automatically updates those entries with corroborated metadata, pricing history, and classification data when a sufficient match is detected.

In some implementations, user feedback can be incorporated to validate or reject provisional entries. For example, user-submitted confirmations or corrections to provisional catalog entries can be received by the platform. The platform can also aggregate the user feedback to assign a consensus validation score to each entry, and promote the entry to confirmed status once the score exceeds a defined threshold. In some implementations, retrieving a corresponding entry in a database for the identified physical collectible item can include weighted features scoring for determining the catalog or database entry that is the best match to the physical collectible item. For example, the identification process for determining the best match in the database can include assigning weights to different extracted features, including visual indicators, manufacturer metadata, and item description keywords, and ranking potential catalog matches according to a weighted similarity score.

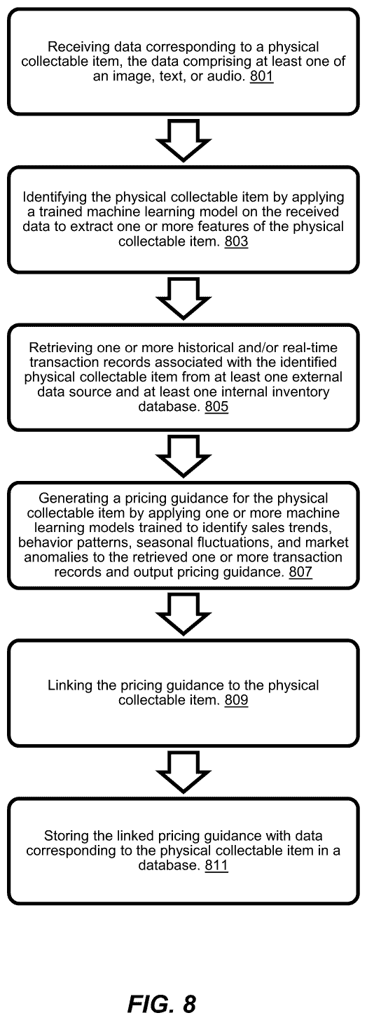

FIG. 8 provides an example of a process implemented by the platform. As shown the process may include the steps of receiving data corresponding to a physical collectible item where the data includes at least one of an image, text, or audio 801, identifying the physical collectible item by applying a trained machine learning model on the received data to extract one or more features of the physical collectible item 803, retrieving one or more historical and/or real-time transaction records associated with the identified physical collectible item from at least one external data source and at least one internal inventory database 805, generating a pricing guidance for the physical collectible item by applying one or more machine learning models trained to identify sales trends, behavior patterns, seasonal fluctuations, and market anomalies to the retrieved one or more transaction records and output pricing guidance 807, linking the pricing guidance to the physical collectible item 809, and storing the linked pricing guidance with data corresponding to the physical collectible item in a database 811.

In some implementations the pricing guidance may correspond to a price value or a range of prices suggested for the current market value of the physical collectible item. The pricing guidance may vary based on the sales channel, historical information, timing of when the item may be transferred or the like. In some implementations the pricing guidance includes an estimated current market value, a pricing range across different sales channels, and/or a time-based recommendation on whether to sell or hold the physical collectible item. In some implementations, a platform may be configured to continuously monitor the price of the physical collectible item across various sales channels and be configured to detect a material change in the pricing guidance. When a material change is detected, the platform may be further configured to notify a user associated with the physical collectible item of the material change in the pricing guidance. Data corresponding to the physical collectible item can include at least one of a photographic image, a textual description, keywords, metadata, a machine-readable barcode, a QR code, or a recorded voice annotation.

The database may be configured to synchronize with external databases and data sources on a periodic basis. Examples of external structured data sources include, but are not limited to, a manufacturer-maintained product database, a third-party online marketplace catalog, and a user-generated public index. Synchronization of the database with external databases and data sources can include ingestion of data including one or more of item metadata, pricing information, and/or classification attributes.

In some implementations the data corresponding to the physical collectible item includes at least two different modalities of input data. In this manner, the data corresponding to the physical collectible item can be verified and confirmed. For example, data corresponding to the physical collectible item can include at least two of the photographic image, the textual description, keywords, metadata, the machine-readable barcode, the QR code, or the recorded voice annotation.

In some implementations, the trained machine learning model may be configured to output a confidence score which is indicative of the confidence with which the retrieved transaction records are associated with the physical collectible item.

In some implementations, generating the pricing guidance includes detecting fluctuations in a value of the physical collectible item based on the retrieved historical and/or real-time transaction records, and by applying a temporal weighting factor.

In some implementations, a system and/or method may include a computer-implemented platform that is used for digital asset cataloging and monetization. In some implementations, the platform can be in communication with a database or a canonical reference catalog that includes structured data entries which correspond to known physical collectible items. In some implementations, the processor can be configured to receive user-submitted data or input that includes text, images, or audio which describes a physical collectible item. The input data can be analyzed using one or more machine learning models that are trained to identify the collectible item in the database by matching extracted features including visual, textual and contextual metadata. In particular, the extracted features may be compared to features in the entries of the database. If there is not a match for the extracted features in the database, a provisional catalog entry for the database can be generated using the extracted data. The provisional catalog entry can also associate itself with the user. In some implementations, the platform can generate a listing for the collectible item including identifying information for the collectible item, metadata for the collectible item. The listing for the collectible item can be updated automatically or semi-automatically with additional corroborating data. The additional corroborating data may be provided with user input, retrieved from external sources, and the like. The listing can be stored in an inventory database. In some implementations it can be assigned to a user profile.

A listing value can be determined by monitoring and tracking data for comparative sales. The comparative sales may also provide insight into behavioral patterns, seasonal patterns, or the like. Listings can be submitted for execution. The listings may be converted and transmitted across different sales channels for execution in accordance with the formatting, pricing requirements, and the like for each sales channel. Listing availability and inventory data can be synchronized across sales channels based on the detected sales activity.

In some implementations, systems and computer-implemented methods can be configured for identifying and cataloging physical collection items using artificial intelligence. For example, a user interface can be provided to a user. The user may provide input data that describes a physical collectible item and includes image, textual information, or speech data. The input data may be received by a processor that applies one or more machine learning models that are trained to extract identifying features of the collectible items. These identifying features can include visual indicators, manufacturer metadata, and subject-related content. The extracted features can be compared to existing entries in a canonical catalog or database that includes listings of previously cataloged collectible items.

As discussed above, in some implementations, the input data can be from a variety of modalities. For example, the input data can include one or more of a photographic image of the physical collectible item, a textual description including keywords or metadata, a machine-readable barcode or QR code, or a recorded voice annotation describing the item's features. The platform can be configured to process each input type using a corresponding recognition module.

In some implementations, the database and catalog can be synchronized with external databases. For example, the canonical catalog can be configured to synchronize periodically with at least one external structured data source, the external source selected from the group consisting of a manufacturer-maintained product database, a third-party online marketplace catalog, and a user-generated public index. The synchronization can include ingestion of item metadata, pricing information, and classification attributes.

In some embodiments, listings in a database can be dynamically adapted across sales channels. For example, for reach generated listing, the platform may dynamically modify the formatting, pricing, and other descriptive elements of the listing based on a rule set and performance metrics associated with a corresponding sales channel. The rule set may include audience behavior patterns, platform-specific fee structures, and historical transaction velocity for comparable items.

In some embodiments, inventory can be synchronized across different sales channels and databases. For example, upon detecting a completed sale transaction for a particular item on any one of integrated sales channels, the platform can be configured to automatically update the item's availability status across all other linked channels to reflect the sale, thereby preventing overselling or duplication, and optionally notifying the user of the inventory status change.

In some implementations, a system and/or method may include a computer-implemented platform that is used for evaluating collectible items, generating pricing guidance, and executing transactions using the generated pricing guidance. The platform may receive data associated with a physical collectible item including identification metadata derived from image, text or speech input. The platform may access a plurality of historical and real-time transaction records associated with the same or similar collectible items from at least one external data source and at least one internal inventory database. The historical and real-time transaction records can be processed by applying one or more machine learning models trained to identify sales trends, behavioral patterns, seasonal fluctuations, and market anomalies associated with the collectible item or a category the collectible item belongs to. The platform can be further configured to generate a pricing guidance output for the collectible item. For example, the pricing guidance can include one or more of: an estimated current market value, a pricing range across different sales channels, and a time-based recommendation for when to sell or hold the item. The generated pricing guidance can be stored in the database in a manner that associates the item and the pricing guidance. Optionally, a notification can be provided to a user associated with the collectible item in response to detecting a material change in the pricing guidance.

In some implementations, seasonal patterns can be incorporated into the generation of the pricing guidance. For example, the pricing guidance generation process includes analyzing historical transaction data to detect cyclical or seasonal fluctuations in item value over time and applying a temporal weighting factor to account for such patterns in the final pricing recommendation. In some implementations, external patterns can be incorporated into pricing guidance. For example, the pricing guidance can be generated based on analyzing the impact of external patterns such as performance of a relating factor, or new releases of similar collectible items, on the item value, and applying a weighting factor to account for such patterns in the final pricing recommendation. In some implementations, the platform may include a real-time alert system for pricing threshold breaches. For example, the platform may determine a material price change event by evaluating whether the updated estimated value of an item deviates from the previously stored guidance by more than a defined percentage or dollar threshold and transmit a notification to a user in response to such an event.

In some implementations, the platform may provide for sales channel-specific pricing adjustment. For example, the pricing guidance system of the platform dynamically adjusts the recommended price of a collectible item based on the rules, fee structures, and audience behavior patterns associated with each external sales platform to which the item may be listed. The pricing adjustments can be based on seller behavior and reputation. For example, the seller behavior and reputation can be reflected in seller reputation data which may include metrics such as fulfillment rate, responsiveness to inquiries, and historical review scores. The seller reputation can be incorporated into the pricing model to adjust the recommended listing price for each individual seller.

In some implementations, time-of-day trends can be detected and incorporated into the market value provided in the pricing guidance. For example, transaction timestamps associated with historical sales data can be analyzed to determine patterns of higher or lower demand for specific items based on time of day or day of week, and such patterns can be used to adjust the pricing recommendation accordingly. The pricing recommendation for the pricing guidance can also include a price elasticity estimation that can be based, at least in part, on the listing duration. For example, an estimated price elasticity curve for the item can be calculated based on historical correlations between listing duration and final sale price and adjusting the guidance price to reflect the estimated impact of delayed sale timelines.

In some implementations, the platform can also provide prioritized bidding and monetization offers based on the buyer profile. For example, the platform can analyze historical bidding and purchasing behavior of prior users and adjust the prioritization of automated monetization offers for a collectible item based on buyer profile matching and likelihood of conversion.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
receiving data corresponding to a physical collectible item, the data comprising at least one of an image, text, or audio;
identifying the physical collectible item by applying a trained machine learning model on the received data to extract one or more features of the physical collectible item;
retrieving a corresponding entry in a database for the identified physical collectible item and updating the corresponding entry to include the physical collectible item, when the corresponding entry is available; and
generating a proposed entry in the database for the identified physical collectible item when the corresponding entry in the database is unavailable.

2. The method of claim 1, wherein each entry in the database comprises a confidence score.

3. The method of claim 2, wherein updating the corresponding entry to include the physical collectible item further comprises increasing the confidence score.

4. The method of claim 2, further comprising: converting the proposed entry into a permanent entry in the database when the confidence score of the proposed entry exceeds a predetermined threshold.

5. The method of claim 1, further comprising updating the proposed entry based on received additional data.

6. The method of claim 1, wherein the data corresponding to the physical collectible item comprises at least one of a photographic image, a textual description, keywords, metadata, a machine-readable barcode, a QR code, or a recorded voice annotation.

7. The method of claim 1, wherein the database is configured to synchronize on a periodic basis with at least one external structured data source, the external structured data source comprising at least one of a manufacturer-maintained product database, a third-party online marketplace catalog, and a user-generated public index, and wherein synchronization comprises ingestion of one or more of item metadata, pricing information, and/or classification attributes.

8. The method of claim 1, further comprising: generating a listing for the physical collectible item based on the corresponding entry in a database for the identified physical collectible item.

9. The method of claim 8, wherein one or more parameters of the generated listing is updated based on a rule set and performance metrics associated with a corresponding sales channel, wherein the one or more parameters of the generated listing comprises one or more of a formatting, pricing, and descriptive elements of the generated listing and wherein the rule set comprises one or more of audience behavior patterns, platform-specific fee structures, and/or historical transaction velocity for comparable items.

10. The method of claim 8, further comprising:
storing the generated listing in the database;
assigning a user profile to the generated listing;
determining a listing value for the generated listing based on data comprising comparative sales tracking and data indicative of behavioral patterns;
convert listings to sales listings compatible with one or more sales channels, wherein the one or more sales channels comprises a formatting and pricing requirement; and
synchronize listing availability and inventory data across the one or more sales channels based on detected sales activity.

11. The method of claim 10, wherein synchronizing listing availability and inventory data across the one or more sales channels based on detected sales activity further comprises:
detecting a completed sale transaction for a particular item on any one of the one or more sales channels; and
automatically update an availability status of the particular item across all other of the one or more sales channels to reflect the sale.

12. The method of claim 11, further comprising: notifying the user of a change in the availability status.

13. A method comprising:
receiving data corresponding to a physical collectible item, the data comprising at least one of an image, text, or audio;
identifying the physical collectible item by applying a trained machine learning model on the received data to extract one or more features of the physical collectible item;
retrieving one or more historical and/or real-time transaction records associated with the identified physical collectible item from at least one external data source and at least one internal inventory database;
generating a pricing guidance for the physical collectible item by applying one or more machine learning models trained to identify sales trends, behavior patterns, seasonal fluctuations, and market anomalies to the retrieved one or more transaction records and output pricing guidance;
linking the pricing guidance to the physical collectible item; and
storing the linked pricing guidance with data corresponding to the physical collectible item in a database.

14. The method of claim 13, wherein the pricing guidance comprises one or more of:
an estimated current market value, a pricing range across different sales channels and a time-based recommendation on whether to sell or hold the physical collectible item.

15. The method of claim 13, further comprising:
detecting a material change in the pricing guidance for the physical collectible item; and
notifying a user associated with the physical collectible item of the material change in the pricing guidance.

16. The method of claim 13, wherein the data corresponding to the physical collectible item comprises at least one of a photographic image, a textual description, keywords, metadata, a machine-readable barcode, a QR code, or a recorded voice annotation.

17. The method of claim 13, wherein the database is configured to synchronize on a periodic basis with at least one external structured data source, the external structured data source comprising at least one of a manufacturer-maintained product database, a third-party online marketplace catalog, and a user-generated public index, and wherein synchronization comprises ingestion of one or more of item metadata, pricing information, and/or classification attributes.

18. The method of claim 16, wherein the data corresponding to the physical collectible item comprises at least two of the photographic image, the textual description, keywords, metadata, the machine-readable barcode, the QR code, or the recorded voice annotation.

19. The method of claim 13, wherein the trained machine learning model is associated with a confidence score indicative of the confidence that the retrieved transaction records are associated with the physical collectible item.

20. The method of claim 13, wherein generating the pricing guidance further comprises:
detecting fluctuations in a value of the physical collectible item based on the retrieved historical and/or real-time transaction records; and
by applying a temporal weighting factor.
